(19) United States
(12) Patent Application Publication
(10) Pub. No.: US 2004/0090165 A1
(43) Pub. Date: May 13, 2004

(54) Electron gun,cathode-ray tube and projector

(76) Inventor: Hirokazu Takuma, Tokyo (JP)

Correspondence Address: Ronald P Kananen, Rader Fishman & Grauer, Suite 501, 1233 20th Street NW, Washington, DC, 20036, US

(21) Appl. No.: 10/471,086

(22) PCT Filed: Mar. 5, 2002
(86) PCT No.: PCT/JP02/02041

(30) Foreign Application Priority Data
Mar. 13, 2001 (JP) 2001-070932

(51) Int. Cl. H01J 29/58; H01J 29/50

(52) U.S. Cl. 313/414; 315/382.1

(57) ABSTRACT

In a cathode ray tube equipped with an electron gun for radiating multiple electron beams each scanning different positions, it is made possible to modulate velocities of the electron beams individually.

There are provided a first velocity modulation coil (9) for generating a magnetic field H₁ that exerts force F₁ on the first electron beam I₁ and a second velocity modulation coil (10) for generating a magnetic field H₂ that exerts force F₂ different from the force F₁ on the second electron beam I₂.

In the cathode ray tube, by modulating the velocities of the electron beams I₁ and I₂ independently of each other, it is possible to improve sharpness without deteriorating a grade of an image.

Further, in a projector equipped with the cathode ray tube, it is possible to improve luminance and also improve sharpness without deteriorating the image grade.

### TECHNICAL FIELD

The present invention relates to an electron gun for radiating multiple electron beams, a cathode ray tube equipped with the electron gun, and a projector equipped with the cathode ray tube. More particularly, it relates to a technology for individually conducting velocity modulation on electron beams each scanning different position to thus improve sharpness without deteriorating a grade of an image.

### BACKGROUND ART

As a method for improving sharpness of an image in a cathode ray tube, Velocity Modulation (VM) has been typically used, by which a scanning velocity of an electron beam is altered instantaneously by a signal created from a luminance signal to thus alter a width of an outline portion of the image.

As means for conducting VM on an electron beam, known is a velocity modulation coil (VM coil) for electro-magnetically deflecting the electron beam to thus modulate a scanning velocity thereof. There is another means referred to as velocity modulation electrode (VM electrode) for electro-statically deflecting an electron beam to thus modulate a scanning velocity thereof. In this case, there is a configuration such that a grid electrode can be used commonly also as the VM electrode.

For example, when using a VM coil, typically a signal obtained by differentiating a luminance signal of a video signal twice and then inverting the differentiated signal is applied to the VM coil to thus alter a scanning velocity of an electron beam due to a deflection yoke so as to enhance a boundary portion between a bright portion and a dark portion of an image, thereby improving sharpness.

FIG. 1 is an explanatory view illustrating a concept of a conventional VM coil. Note that, in FIG. 1, a neck portion 13 of a cathode ray tube is viewed from a side of an electron gun (not shown) in a direction toward a phosphor screen (not shown).

A VM coil 14 is provided to alter a horizontal scanning velocity of an electron beam I. The VM coil 14 is thus provided to generate a vertical magnetic field H at the neck portion 13 etc. of the cathode ray tube.

Accordingly, the electron beam I is subject to horizontal force F, so that the horizontal scanning velocity of the electron beam I can be increased and decreased.

FIG. 2 is an explanatory view illustrating a concept of a conventional VM coil wherein multiple electron beams are used.

For example, in a case where two electron beams are used, by providing the VM coil 14 in such a manner that the vertical magnetic field H may occur at the neck portion 13 etc. of a cathode ray tube, each of the electron beams I₁ and I₂ is subject to the horizontal force F, so that their respective horizontal scanning velocities can be increased and decreased simultaneously.

Conventionally, the VM coil is provided to use a same signal to simultaneously modulate scanning velocities of one or a plurality of electron beams and it has been impossible to individually conduct velocity modulation on the multiple electron beams.

### DISCLOSURE OF THE INVENTION

To solve the problem, the present invention has been developed, and it is an object of the present invention to provide an electron gun, a cathode ray tube, and a projector that can conduct velocity modulation individually on multiple electron beams in the cathode ray tube.

An electron gun for radiating multiple electron beams related to the present invention is equipped with a VM electrode for generating an electric field that exerts force on each of the electron beams individually.

Further, a cathode ray tube related to the present invention is equipped with an electron gun for radiating multiple electron beams, and the electron gun comprises a VM electrode for generating an electric field that exerts force individually on each of the electron beams to modulate the scanning velocities thereof.

Further, another cathode ray tube related to the present invention is equipped with an electron gun for radiating multiple electron beams, and the cathode ray tube comprises a VM coil for generating a magnetic field that exerts force individually on each of the electron beams radiated from the electron gun.

Further, a projector related to the present invention is equipped with three cathode ray tubes for emitting three monochromatic lights of red, green, and blue respectively, each of the cathode ray tubes into which an electron gun for radiating multiple electron beams is installed, wherein each of the electron guns comprises a VM electrode for generating an electric field that exerts force individually on each of the electron beams to thus modulate scanning velocities thereof.

Further, another projector related to the present invention is equipped with three cathode ray tubes for emitting three monochromatic lights of red, green, and blue, respectively. In the projector having the cathode ray tubes into which an electron gun for radiating multiple electron beams is installed, each of the cathode ray tubes comprises a VM coil for generating a magnetic field that exerts force individually on each of the electron beams radiated from the electron gun to thus modulate scanning velocities thereof.

According to the electron gun related to the present invention, individual force can be exerted on multiple electron beams to thus modulate velocities of the electron beams individually. Incorporating such the electron gun into a cathode ray tubes and a projector related to the present invention allows the velocities of multiple electron beams in the cathode ray tube to be modulated individually, thereby improving sharpness without deteriorating a grade of an image.

Further, according to cathode ray tube related to the present invention, exerting individual force on multiple electron beams radiated from an electron gun allows velocities of the multiple electron beams in the cathode ray tube to be modulated individually, thereby improving sharpness without deteriorating a grade of an image. According to the projector related to the present invention, incorporating such the cathode ray tube allows velocities of the multiple electron beams in each of the cathode ray tubes to be modulated individually, thereby improving sharpness without deteriorating a grade of an image.

### BRIEF DESCRIPTION OF THE DRAWINGS

FIG. 1 is an explanatory view illustrating a concept of a conventional VM coil;

FIG. 2 is an explanatory view illustrating a concept of the conventional VM coil wherein two electron beams are used;

FIG. 3 is a cross-sectional side view showing a configuration outline of a cathode ray tube;

FIG. 4 is an explanatory view illustrating a VM coil showing a concept of the present invention;

FIG. 5 is an explanatory view illustrating a VM coil according to a first embodiment of the present invention; and

FIG. 6 is an explanatory view illustrating a VM coil according to a second embodiment of the present invention.

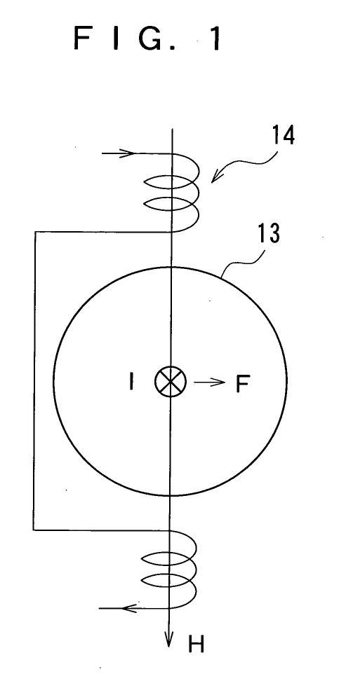

### BEST MODE FOR CARRYING OUT THE INVENTION

A television receiver is desired to have a larger screen to provide viewer(s) with a realistic and punchy image. In this case, according to a method for increasing a size of a color cathode ray tube, the cathode ray tube up to about 40 inches has been presently implemented. In a case of the cathode ray tube of about 40 inches, however, a related television receiver weights more than 100 kg and it is difficult to install such the television receiver in a common home.

To solve the problem, as the projector having a large screen through which viewer(s) can easily watch television in the common home, a rear-type projector using a cathode ray tube has been widely used.

The rear-type projector uses lenses to expand and project images thrown by three monochromatic cathode ray tubes for red (R), green (G), and blue (B) so that a resultant image thus synthesized may be viewed through a transmission type screen. The monochromatic cathode ray tubes have a size of about 7-9 inches and the image thereof is expanded on a screen having a size of about 40-60 inches, so that luminance of the image is decreased greatly. Therefore, the screen is given a directivity of light to decrease a vertical visibility angle in order to increase luminance, which, however, deteriorates a display grade.

To improve the luminance without deteriorating the display grade, a variety of methods have been thought out. It has been thought out to produce such a projector as to increase the number of electron beams of a monochromatic cathode ray tube, which has been one conventionally, to n, thus improving the luminance.

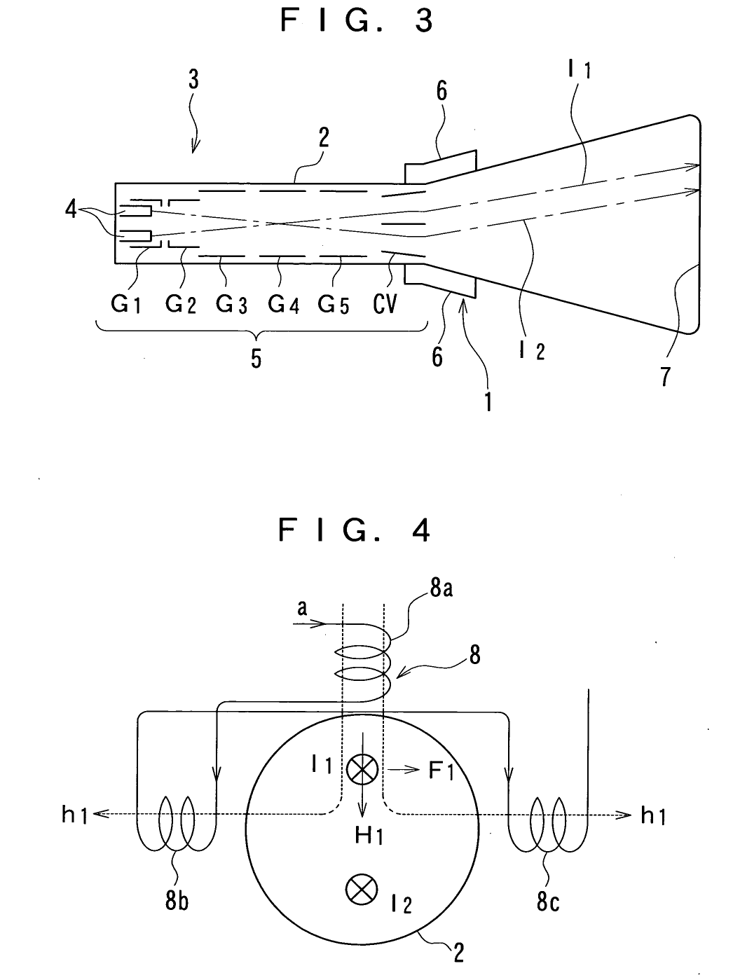

FIG. 3 is a cross-sectional view showing a configuration outline of a cathode ray tube using two electron beams for each color and, actually is a cross-sectional side view obtained by cutting the cathode ray tube vertically. Note that a cathode ray tube 1 shown in FIG. 3 illustrates the one used in a projector.

A neck portion 2 of the cathode ray tube 1 integrates an electron gun 3. The electron gun 3 comprises two cathode electrodes 4, multiple grid electrodes 5, for example, five grids electrodes indicated by G1-G5, and a convergence deflector CV. The cathode ray tube 1 is provided with a deflection yoke 6 for deflecting electron beams I radiated from the electron gun 3, in this case, two electron beams I₁ and I₂. Note that the projector uses separate cathode ray tubes 1 for each of R (red), G (green), and B (blue), so that, for example, a blue phosphor is applied on a phosphor screen 7 of the cathode ray tube 1 corresponding to blue.

In a case where the electron beam I is given two, if the electron beams I₁ and I₂ are converged on the phosphor screen 7, a luminance saturation phenomenon due to a rise in current density causes the blue phosphor to have a luminance rising rate decreased even if a current is increased. Therefore, a white peak portion where a larger current flows through is decreased in color temperature to thus look yellowish white, which deteriorates a display grade.

To remedy the luminance saturation phenomenon, a method is available for, in the case of the monochromatic cathode ray tube 1, inhibiting luminance saturation by suppressing a rise in current density not by converging the two electron beams I₁ and I₂ on the phosphor screen 7 but by scanning them vertically on the screen with shifting them from each other in time.

In this case, since the two electron beams I₁ and I₂ scan different positions, if the same video signal is input, a resultant image is displayed as blurred, so that by delaying an incoming video signal of one to be delay scanned of the scanning electron beams, for example, the electron beam I₂ by a time that corresponds to a difference in position between the two electron beams I₁ and I₂, it is possible to converge the images.

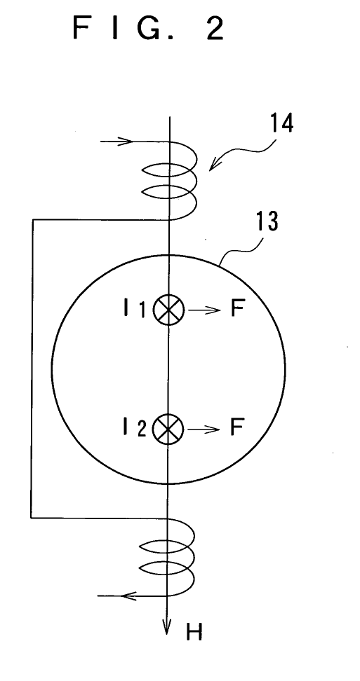

Although, as described above, a velocity modulation method by use of a VM coil is typically used to improve sharpness of an image, if a conventional VM coil is used in the monochromatic cathode ray tube 1 using the two electron beams I₁ and I₂ for each color, a magnetic field applies force on both of the electron beams I₁ and I₂ as shown in FIG. 2, thus modulating the velocities of the two electron beams I₁ and I₂ simultaneously. As described above, the two electron beams I₁ and I₂ scan different positions, so that if they are subject to simultaneous velocity modulation, a grade of the image is deteriorated greatly. Therefore, the conventional VM coil cannot be used in the monochromatic cathode ray tube 1 using the two electron beams I₁ and I₂ for each color.

To solve this problem, according to the present invention, a VM coil is arranged in such a manner that multiple electron beams can undergo velocity modulation individually.

That is, FIG. 4 is an explanatory view of a VM coil showing a concept of the present invention. In FIG. 4, the neck portion 2 of the cathode ray tube 1 shown in FIG. 3 is viewed from the side of the electron gun 3 in a direction toward the phosphor screen 7, with the two electron beams I₁ and I₂ each going from you in a depth direction. Further, FIG. 4 shows a condition where the two electron beams I₁ and I₂ are respectively arranged up and down vertically with respect to their scanning directions.

The VM coil 8 improves sharpness of an image by instantaneously altering a horizontal scanning velocity of the electron beams I at such an outline portion etc. of the image as to have a large variation in luminance. In order to apply force F₁, however, only on one electron beam of two electron beams I, the upper side electron beam I₁ in this case, a coil 8a is provided vertically above a pathway of the electron beams I such as a portion of the electron gun 3 where the grid electrodes 5 are installed or the neck portion 2 of the cathode ray tube 1 and also coils 8b and 8c are provided on both horizontal sides, respectively. In such a configuration, if a current is flown, for example, in a direction indicated by arrow “a”, magnetic field h₁ as indicated by broken lines is generated in directions from the coils 8a to 8b and magnetic field h₁ as indicated by broken lines is also generated in directions from the coils 8a to 8c, thereby generating a vertical magnetic field H₁ with respect to the upper-side electron beam I₁.

Therefore, the upper-side electron beam I₁ is subject to the horizontal force F₁, so that by altering a direction in which a current flows through the VM coil 8, it is possible to increase or decrease a horizontal scanning velocity of the upper-side electron beam I₁.

Note that the lower-side electron beam I₂ is also subject to the force in the magnetic field due to the VM coil 8 but to such an extent as to be negligible. Further, the VM coil 8 may be incorporated in the deflection yoke 6 shown in FIG. 3.

By thus arranging the VM coil 8 in such a manner as to generate a magnetic field that applies force only on one of the two electron beams I₁ and I₂ scanning different positions, it is possible to modulate a velocity of that one electron beam. Therefore, by providing a VM coil for generating a magnetic field that exerts force on the two electron beams I₁ and I₂ scanning different positions, independently of each other, it is possible to modulate the velocities of the two electron beams I₁ and I₂ individually.

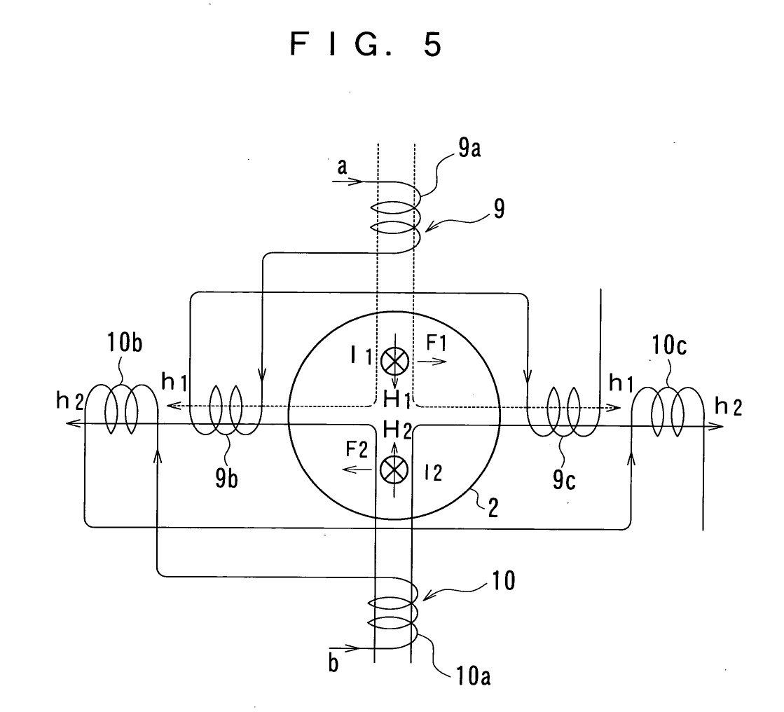

That is, FIG. 5 is an explanatory view of a VM coil according to a first embodiment of the present invention. In FIG. 5, the neck portion 2 of the cathode ray tube 1 shown in FIG. 3 is viewed from the side of the electron gun 3 in the direction toward the phosphor screen 7, with the two electron beams I₁ and I₂ each going from you in a depth direction. Further, FIG. 5 shows a condition where the two electron beams I₁ and I₂ are respectively arranged up and down vertically with respect to their scanning directions.

In the first embodiment, as a VM coil working to instantaneously alter a horizontal scanning velocity of an electron beams I at such an outline portion etc. of an image as to have a large variation in luminance in order to improve sharpness of the image, two suites of VM coils of a first VM coil 9 and a second VM coil 10 are provided to modulate velocities of two electron beams I₁ and I₂ by using different signals respectively.

As the first velocity coil 9 is desired to apply force F₁ only on the upper-side electron beam I₁ of the two electron beams I, a coil 9a is provided vertically above a pathway of the electron beams I such as a portion of an electron gun 3 where a grid electrode 5 is installed or a neck portion 2 of a cathode ray tube 1 and also coils 9b and 9c are provided on both horizontal sides respectively. In such a configuration, if a current is flown through the first VM coil 9, for example, in a direction indicated by arrow “a”, magnetic field h₁ as indicated by broken lines is generated in direction from the coils 9a to 9b and magnetic field h₁ as indicated by broken lines is also generated in direction from the coils 9a to 9c, thereby generating a vertical magnetic field H₁ with respect to the upper-side electron beam I₁.

Therefore, the upper-side electron beam I₁ is subject to the horizontal force F₁, so that by altering a direction in which a current flows through the VM coil 9, it is possible to increase or decrease a horizontal scanning velocity of the upper-side electron beam I₁.

As the second VM coil 10 is desired to apply force F₂ only on the lower-side electron beam I₂ of the two electron beams I, a coil 10a is provided vertically below a pathway of the electron beams I such as the portion of the electron gun 3 where the grid electrode 5 is installed or the neck portion 2 of the cathode ray tube 1 and also coils 10b and 10c are provided on the both horizontal sides respectively. The coil 10b of the second VM coil 10 is provided on the same axis as the coil 9b of the first VM coil 9. Similarly, the coil 10c of the second VM coil 10 is provided on the same axis as the coil 9c of the first VM coil 9.

In such a configuration, if a current is flown through the second VM coil 10, for example, in a direction indicated by arrow “b”, magnetic field h₂ as indicated by solid lines is generated in direction from the coils 10a to 10b and magnetic field h₂ as indicated by solid lines is also generated from the coils 10a to 10c, thereby generating a vertical magnetic field H₂ with respect to the lower-side electron beam I₂.

Therefore, the lower-side electron beam I₂ is subject to the horizontal force F₂, so that by altering a direction in which a current flows through the VM coil 10, it is possible to increase or decrease a horizontal scanning velocity of the lower-side electron beam I₂.

Note that the upper-side electron beam I₁ is subject to the force in the magnetic field due to the second VM coil 10 and the lower-side electron beam I₂ is subject to the force in the magnetic field due to the first VM coil 9; however, both of the force exerted on the upper-side electron beam I₁ by the second VM coil 10 and the force exerted on the lower-side electron beam I₂ by the first VM coil 9 are of such a magnitude as to be negligible.

Thus, by arranging the first VM coil 9 and the second VM coil 10 in the cathode ray tube in such a manner as to generate magnetic fields that apply force independently of each other on the two electron beams I₁ and I₂ scanning different positions, it is possible to modulate velocities of the two electron beams I₁ and I₂ individually by using different signals respectively. By using the cathode ray tube in, for example, a projector, it is possible to improve luminance and also improve sharpness using two electron beams for each color without deteriorating a grade of an image.

The coil 9b of the first VM coil 9 and the coil 10b of the second VM coil 10 may be of such a structure that, for example, the coil 10b is stacked inside the coil 9b. Similarly, the coil 9c of the first VM coil 9 and the coil 10c of the second VM coil 10 may be of such a structure that, for example, the coil 10c is stacked inside the coil 9c.

Further, the first VM coil 9 and the second VM coil 10 may be incorporated into a deflection yoke 6 as shown in FIG. 3.

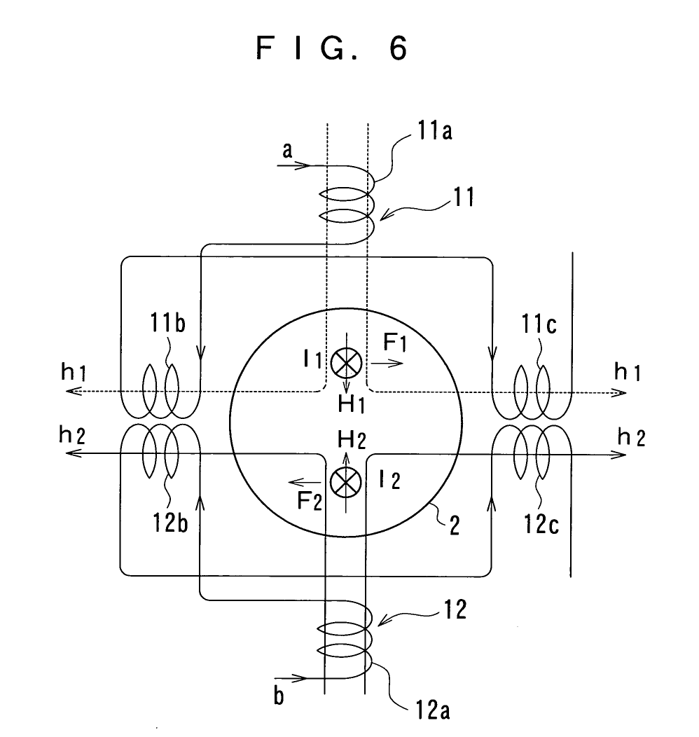

FIG. 6 is an explanatory view of a VM coil according to a second embodiment of the present invention. In FIG. 6, the neck portion 2 of the cathode ray tube 1 shown in FIG. 3 is viewed from a side of the electron gun 3 in a direction toward the phosphor screen 7, with two electron beams I₁ and I₂ each going from you in a depth direction. Further, FIG. 6 shows a condition where the two electron beams I₁ and I₂ are respectively arranged up and down vertically with respect to their scanning directions.

In the second embodiment, as a VM coil working to instantaneously alter a horizontal scanning velocity of an electron beams I at such an outline portion etc. of an image as to have a large variation in luminance in order to improve sharpness of the image, two suites of VM coils of a first VM coil 11 and a second VM coil 12 are provided to modulate velocities of two electron beams I₁ and I₂ by using different signals respectively.

As the first VM coil 11 is desired to apply force F₁ only on the upper-side electron beam I₁ of the two electron beams I, a coil 11a is provided vertically above a pathway of the electron beams I such as a portion of the electron gun 3 where grid electrodes 5 are installed or the neck portion 2 of a cathode ray tube 1 and also coils 11b and 11c are provided on both horizontal sides respectively. In such a configuration, if a current is flown through the first VM coil 11, for example, in a direction indicated by arrow “a”, magnetic field h₁ as indicated by broken lines is generated in direction from the coils 11a to 11b and magnetic field h₁ as indicated by broken lines is generated in direction from the coils 11a to 1c, thereby generating a vertical magnetic field H₁ with respect to the upper-side electron beam I₁.

Therefore, the upper-side electron beam I₁ is subject to the horizontal force F₁, so that, by altering a direction in which a current flows through the VM coil 11, it is possible to increase or decrease a horizontal scanning velocity of the upper-side electron beam I₁.

As the second VM coil 12 is desired to apply force F₂ only on the lower-side electron beam I₂ of the two electron beams I, a coil 12a is provided vertically below a pathway of the electron beams I such as the portion of the electron gun 3 where the grid electrodes 5 are installed or the neck portion 2 of the cathode ray tube 1 and also coils 12b and 12c are provided on both horizontal sides respectively. The coil 12b of the second VM coil 12 is provided at a position where it does not overlap with the coil 11b of the first VM coil 11 so that the coil 12b may not be easily influenced by the magnetic field h₁ coming from the coil 11a to the coil 11b. Similarly, the coil 12c of the second VM coil 12 is provided at a position where it does not overlap with the coil 11c of the first VM coil 11 so that the coil 12c may not be easily influenced by the magnetic field h₁ coming from the coil 11a to the coil 11c.

In such a configuration, if a current is flown through the second VM coil 12, for example, in a direction indicated by arrow “b”, magnetic field h₂ as indicated by solid lines is generated in direction from the coils 12a to 12b and magnetic field h₂ as indicated by solid lines is generated in direction from the coils 12a to 12c, thereby generating a vertical electric field H₂ with respect to the lower-side electron beam I₂.

Therefore, the lower-side magnetic beam I₂ is subject to the horizontal force F₂, so that, by altering a direction in which a current flows through the VM coil 12, it is possible to increase or decrease a horizontal scanning velocity of the lower-side electron beam I₂.

Note that the upper-side electron beam I₁ is subject to the force in the magnetic field due to the second VM coil 12 and the lower-side electron beam I₂ is subject to the force in the magnetic field due to the first VM coil 11; however, both the force exerted on the upper-side electron beam I₁ by the second VM coil 12 and the force exerted on the lower-side electron beam I₂ by the first VM coil 11 are of such a magnitude as to be negligible.

By thus arranging the first VM coil 11 and the second VM coil 12 in the cathode ray tube in such a manner as to generate magnetic fields that apply force independently of each other on the two electron beams I₁ and I₂ scanning different positions, it is possible to modulate velocities of the two electron beams I₁ and I₂ individually by using different signals respectively. By using the cathode ray tube in, for example, a projector, it is possible to improve luminance and also improve sharpness using two electron beams for each color without deteriorating a grade of an image.

The coil 11b of the first VM coil 11 and the coil 12b of the second VM coil 12 may be of such a structure that they may overlap partially. Similarly, the coil 11c of the first VM coil 11 and the coil 12c of the second VM coil 12 may be of such a structure that they may overlap partially.

Further, the first VM coil 11 and the second VM coil 12 may be incorporated into a deflection yoke 6 as shown in FIG. 3.

Note that velocity modulation in the cathode ray tube 1 as shown in FIG. 3 may be realized by actions of electrostatic deflection by use of a VM electrode besides by actions of electromagnetic deflection by use of the VM coil described according to FIG. 4 or 5.

Therefore, by providing such a configuration of a cathode ray tube provided with two electron guns, for each color, in each of which a grid electrode is arranged for each cathode electrode to divide, for example, a focus grid of the grid electrode of each cathode into right and left ones so that the mutually opposite grid electrodes may be supplied with a control voltage for velocity modulation, with the upper-side and lower-side grid electrodes working to supply a different control voltage, it is possible to exert different magnitudes of force on two electron beams scanning different positions, thereby velocity modulating the two electron beams by using different signals individually. By using the cathode ray tube in, for example, a projector, it is possible to use two electron beams for each color to thereby improve luminance and sharpness without deteriorating a grade of an image.

Although the embodiments have been described with reference to an example of a monochromatic cathode ray tube used in a projector, the present invention can be applied to an ordinary cathode ray tube. Further, the electron beams may be given two or more for each color.

As described above, the present invention relates to the electron gun for radiating multiple electron beams, comprising the VM electrode for generating an electric field that exerts force on each of the electron beams individually.

Further, the present invention relates to the cathode ray tube equipped with the electron gun that radiates multiple electron beams, the electron gun comprising a VM electrode for generating an electric field that exerts force individually on each of the electron beams to thus modulate a scanning velocity thereof.

Still further, the present invention relates to the cathode ray tube equipped with the electron gun that radiates multiple electron beams, comprising a VM coil for generating a magnetic field that exerts force individually on each of the electron beams radiated by the electron gun.

In the electron gun related to the present invention, each of the multiple electron beams can be subject to velocity modulation individually by supplying the electron beams with force individually. By incorporating the electron gun into the cathode ray tube, it is possible to individually modulate velocities of the multiple electron beams in the cathode ray tube, thereby improving sharpness without deteriorating a grade of an image.

Further, in a cathode ray tube related to the present invention, each of the multiple electron beams in the cathode ray tube can be subject to velocity modulation individually by supplying the electron beams with force individually, thereby improving sharpness without deteriorating a grade of an image.

Therefore, in a projector equipped with such a cathode ray tube as described above, by using multiple electron beams for each color, it is possible to improve luminance and also improve sharpness without deteriorating a grade of an image even on a large screen.

### INDUSTRIAL APPLICABILITY

An electron gun, a cathode ray tube, and a projector, which are related to the present invention, are suited for use in an apparatus which displays an image by using multiple electron beams for each color.

1. An electron gun for radiating multiple electron beams, said electron gun comprising a velocity modulation electrode for generating an electric field that exerts force individually on each of said electron beams.

2. The electron gun according to claim 1, wherein a grid electrode is used as said velocity modulation electrode.

3. A cathode ray tube equipped with an electron gun for radiating multiple electron beams, wherein said electron gun comprises a velocity modulation electrode for generating an electric field that exerts force individually on each of said electron beams to thus modulate a scanning velocity thereof.

4. The cathode ray tube according to claim 3, wherein a grid electrode is used as said velocity modulation electrode.

5. The cathode ray tube according to claim 3, wherein the number of said electron beams radiated from said electron gun is two for each color.

6. A cathode ray tube equipped with an electron gun for radiating multiple electron beams, comprising a velocity modulation coil for generating a magnetic field that exerts force individually on each of said electron beams radiated from said electron gun.

7. The cathode ray tube according to claim 6, wherein said velocity modulation coil is incorporated into a deflection yoke for deflecting said electron beams.

8. The cathode ray tube according to claim 6, wherein the number of said electron beams radiated from said electron gun is two for each color.

9. A projector equipped with three monochromatic cathode ray tubes for red, green, and blue, each of said cathode ray tubes being provided with an electron gun for radiating multiple electron beams, wherein each of said electron guns comprises a velocity modulation electrode for generating a electric field that exerts force individually on each of said electron beams to thus modulate a scanning velocity thereof.

10. The projector according to claim 9, wherein a grid electrode is used as said velocity modulation electrode.

11. The projector according to claim 9, wherein the number of said electron beams radiated from said electron gun is two for each color.

12. A projector equipped with three monochromatic cathode ray tubes for red, green, and blue, each of said cathode ray tubes being provided with an electron gun for radiating multiple electron beams, comprising a velocity modulation coil for generating a magnetic field that exerts force individually on each of said electron beams radiated from said electron gun to thus modulate a scanning velocity thereof.

13. The projector according to claim 12, wherein said velocity modulation coil is incorporated into a deflection yoke for deflecting said electron beams.

14. The projector according to claim 12, wherein the number of said electron beams radiated from said electron gun is two for each color.
